(19) United States
(12) Patent Application Publication
(10) Pub. No.: US 2014/0041540 A1
(43) Pub. Date: Feb. 13, 2014

(54) SCREEN PRINTING DEVICE OF HIGH PRECISION

(71) Applicants: GA-LANE CHEN, Santa Clara, CA (US); CHUNG-PEI WANG, New Taipei (TW)

(72) Inventors: GA-LANE CHEN, Santa Clara, CA (US); CHUNG-PEI WANG, New Taipei (TW)

(21) Appl. No.: 13/678,427

(22) Filed: Nov. 15, 2012

(30) Foreign Application Priority Data
Aug. 7, 2012 (TW) 101128369

(51) Int. Cl. B41F 15/18

(52) U.S. Cl. CPC B41F 15/18
USPC 101/126

(57) ABSTRACT

A screen printing device includes a supporting base, a stencil, and an imaging alignment device. The supporting base includes a supporting surface and defines a blind hole in the supporting surface for receiving an optic, with a gap therebetween less than 0.1 mm. The stencil is positioned on the supporting base and defines an open pattern and forms at least three marks on a surface of the stencil facing away the supporting base. The imaging alignment device is positioned above the stencil and configured to capture a number of images of the stencil, analyze the images, and reposition the stencil according to analyzing results of the images so that images of the marks reach predetermined positions. The imaging alignment device, the stencil, and the supporting base are pre-aligned such that when the images of the marks reach the predetermined positions, the open pattern aligns with the blind hole.

### BACKGROUND

1. Technical Field

The present disclosure relates to screen printing technologies and particularly to a high precision screen printing device.

2. Description of Related Art

Screen printing can be used to print desired patterns on the optics. However, the precision of the screen printing often fails to meet of the precision requirements of the optics.

Therefore, it is desirable to provide a screen printing device, which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric, exploded, schematic view of a screen printing device, according to an embodiment.

FIG. 2 is an isometric schematic view of a supporting base and a stencil of the screen printing device of FIG. 1.

FIG. 3 is a cross-sectional schematic view taken along a line of FIG. 2.

FIG. 4 is an enlarged schematic view of a portion IV of FIG. 3.

### DETAILED DESCRIPTION

Embodiments of the present disclosure will now be described in detail with reference to the drawings.

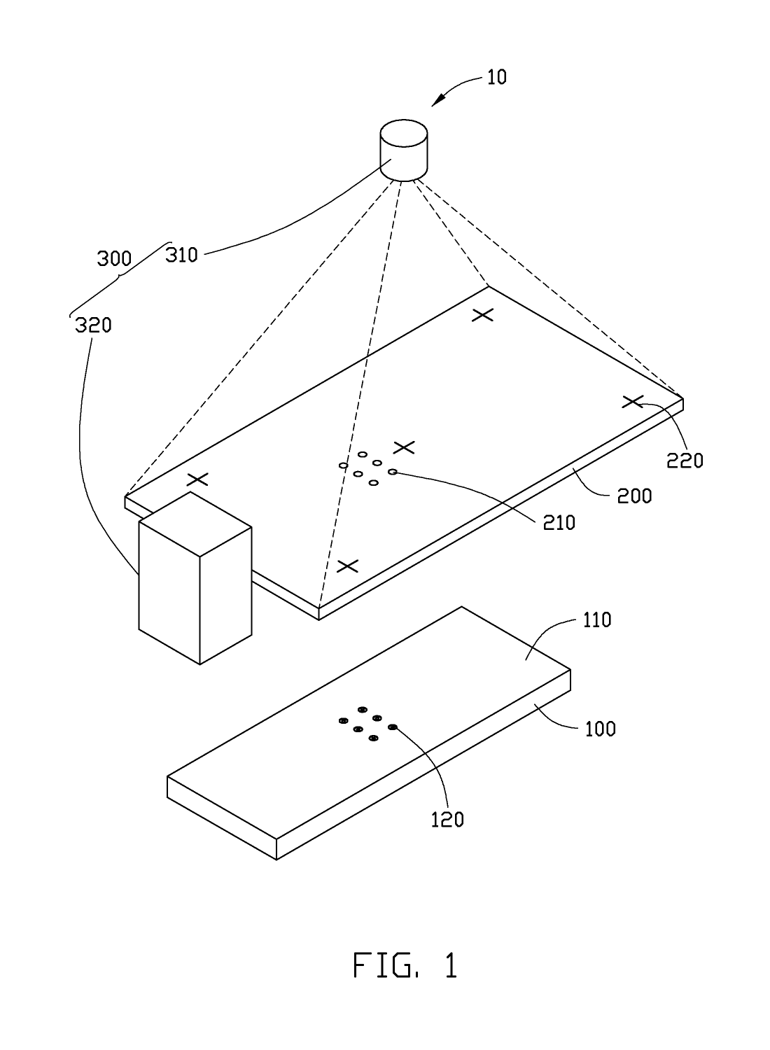

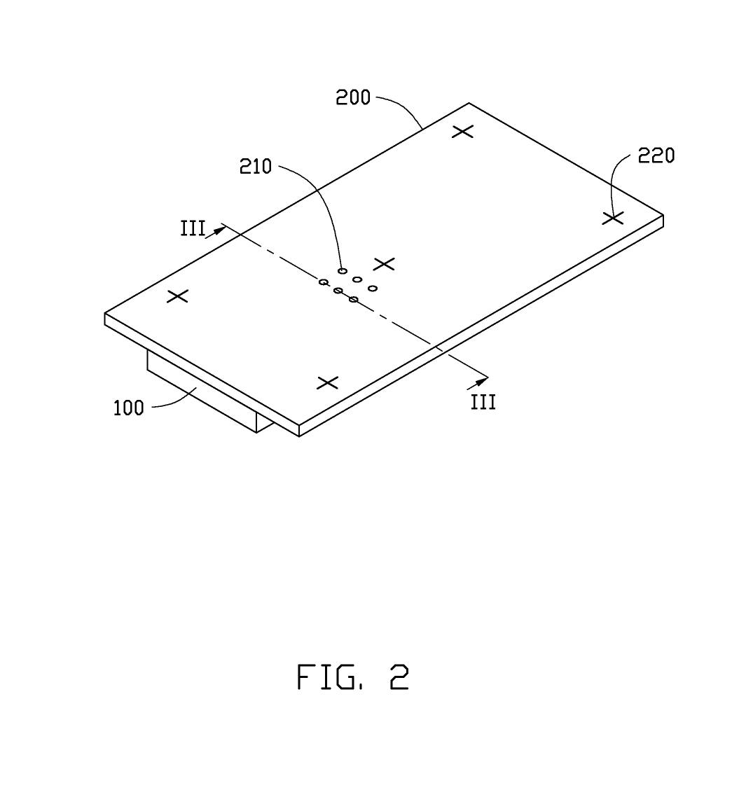

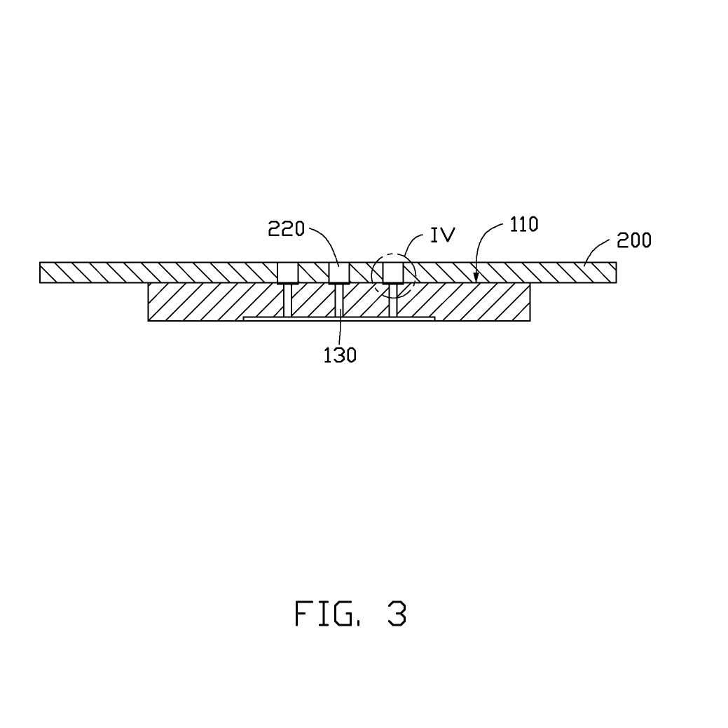

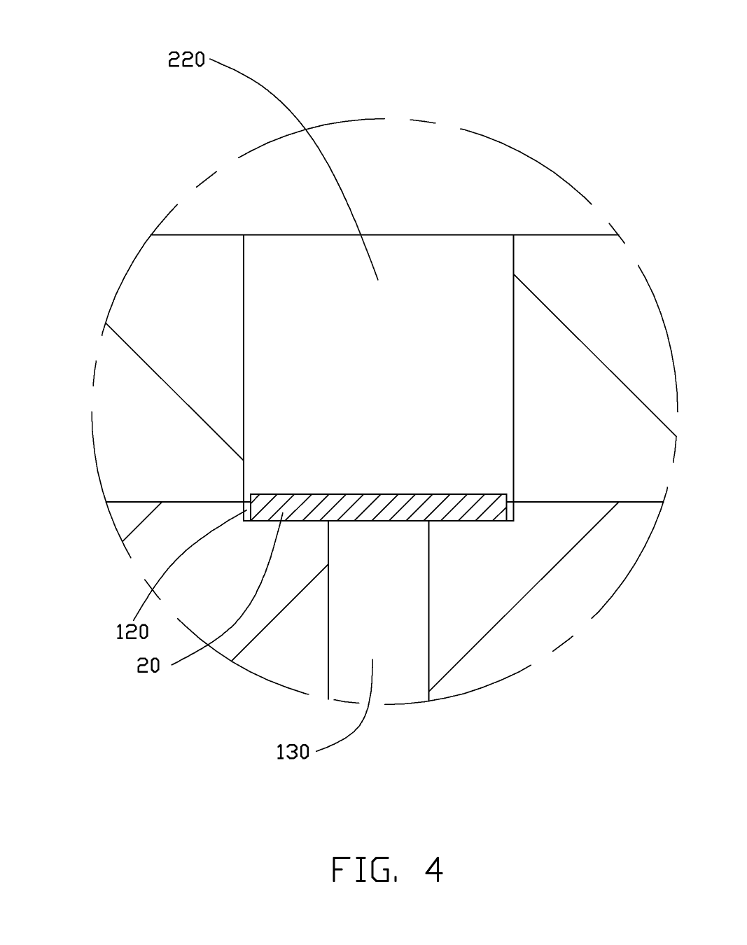

Referring to FIGS. 1-4, an embodiment of a screen printing device 10 includes a supporting base 100, a stencil 200, and an imaging alignment device 300. The supporting base 100 includes a supporting surface 110 and defines an array of receiving blind holes 120 in the supporting surface 110. Each blind hole 120 is for receiving an optic 20 to be printed. A gap between the boundary of each blind hole 120 and the corresponding optic 20 is less than 0.1 mm. The stencil 200 is positioned on the supporting base 100. The stencil 200 defines an array of open patterns 210, corresponding to the blind holes 120, and forms five marks 220 at four corners and the center of a surface thereof facing away the supporting base 100. The imaging alignment device 300 is positioned above the stencil 200 and configured to capture images of the stencil 200, analyze the images, and reposition the stencil 200 according to analyzing results of the images so that images of the marks 220 reach predetermined positions. The imaging alignment device 300, the stencil 200, and the supporting base 100 are pre-aligned such that when the images of the marks 220 reach the predetermined positions, the open patterns 210 align with the respective blind holes 120.

As such, the precision of the screen printing device 10 is controlled with in ±0.1 mm, which can meet the precision requirements of optics.

The optics 20 can be a circular sapphire substrate. The open pattern 210 transfer printable light-shielding materials, such as ink, on the corresponding optic 20 as a light-shielding region on the optic 20.

In the embodiment, the number of the blind holes 120 is six and arranged in a 2×3 array. The depth of the blind hole 120 is slightly smaller than the height of the optic 20, and is about 0.0508 mm. As such, the optic 20 can slightly protrude out the supporting surface 110. Thus, the optic 20 can gaplessly contact the stencil 20 so that the light-shielding region can have sharp edges.

The supporting base 10 defines a number of through holes 130 corresponding to the blind holes 120. Each through hole 130 has a diameter smaller than the diameter of the corresponding blind hole 120 and aligns with the corresponding blind hole 120. Each through hole 130 communicates the corresponding blind hole 120 with an air pump to absorb the corresponding optic 20 in the blind hole 120.

In the embodiment, the gap between the boundary of each blind hole 120 and the optic 20 is less than 0.0508 mm.

The stencil 200 is substantially rectangular. Each open pattern 210 is a circular hole.

The imaging alignment device 300 includes an image capture device 310 and an actuator 320. The image capture device 310 is fixed in relative to the supporting base 100 and configured for capturing the images. The actuator 320 is connected to the image capture device 310 and the stencil 200 and configured to analyze the images and reposition the stencil 200 based upon the analyzing results.

In practice, the imaging alignment device 300, the stencil 200, and the supporting base 100 can be pre-aligned using other methods, such as visual inspection.

The number and arrangement of the blind holes 120 are not limited to this embodiment, and can be set as desired. The number and arrangement of the through holes 130 and the open patterns 210 should be change correspondingly. For example, in another embodiment, only one blind hole, one through hole and on open pattern can be employed.

The number and arrangement of the marks 220 are also not limited by this embodiment.

In other embodiment, only three or more masks can be employed and arranged in other forms.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A screen printing device, comprising:
a supporting base comprising a supporting surface and defining a blind hole in the supporting surface for receiving an optic to be printed, a gap between the boundary of the blind hole and the optic being less than 0.1 mm;
a stencil positioned on the supporting base and defining an open pattern and forming at least three marks on a surface of the stencil facing away the supporting base; and
an imaging alignment device positioned above the stencil and configured to capture a plurality of images of the stencil, analyze the images, and reposition the stencil according to analyzing results of the images so that images of the marks reach predetermined positions;
wherein the imaging alignment device, the stencil, and the supporting base are pre-aligned such that when the images of the marks reach the predetermined positions, the open pattern align the blind hole.

2. The screen printing device of claim 1, wherein the optic is a circular sapphire substrate, and the open pattern is configured to transfer printable light-shielding materials on the optic as an light-shielding region on the optic.

3. The screen printing device of claim 1, wherein the depth of the blind hole is slightly smaller than the height of the optic.

4. The screen printing device of claim 1, wherein the depth of the blind hole is smaller than the height of the optic about 0.0508 mm.

5. The screen printing device of claim 1, wherein the supporting base defines a through hole, the through hole has a diameter smaller than that of the blind hole and aligns with the blind hole, and the through hole is configured to communicate the blind hole with an air pump to absorb the optic in the blind hole.

6. The screen printing device of claim 1, wherein the gap between the boundary of the blind hole and the optic is less than 0.0508 mm.

7. The screen printing device of claim 1, wherein the imaging alignment device comprises an image capture device and an actuator, the image capture device is fixed in relative to the supporting base and configured for capturing the images, and the actuator is connected to the image capture device and the stencil and configured to analyze the images and reposition the stencil based upon the analyzing results.
